(19) United States
(12) Patent Application Publication
(10) Pub. No.: US 2021/0024274 A1
(43) Pub. Date: Jan. 28, 2021

(54) SECURE STORAGE VESSELS AND METHODS OF USING THE SAME

(71) Applicant: Jared Stipelman, Manalapan, NJ (US)

(72) Inventor: Jared Stipelman, Manalapan, NJ (US)

(21) Appl. No.: 16/907,168

(22) Filed: Jun. 19, 2020

Related U.S. Application Data
(60) Provisional application No. 62/878,743, filed on Jul. 25, 2019.

(51) Int. Cl. B65D 81/32; B65D 55/14; B65D 41/04

(52) U.S. Cl. CPC B65D 81/3222; A61J 1/00; B65D 41/04; B65D 55/14

(57) ABSTRACT

The present disclosure provides secure storage containers, e.g., which may be used as a vessel to store and/or transport medication, controlled substances, and other materials.

### CROSS-REFERENCE TO RELATED APPLICATION

This application claims priority to U.S. Provisional Patent Application No. 62/878,743, filed Jul. 25, 2019, the entire contents of which is incorporated herein in its entirety.

### FIELD OF THE INVENTION

This disclosure generally relates to secure storage vessels and related devices, e.g., which may be used to store and/or transport medication, controlled substances, and other materials.

### BACKGROUND

According to recent studies, more than half of all Americans take at least one prescription medication on a regular basis. Indeed, prescription drug use has steadily grown over time, and this trend is likely to continue. Modern medicine and surgical techniques are allowing people to live longer, resulting in a long-term shift towards a more elderly population. Older individuals tend to take more prescription medication (e.g., cholesterol or blood pressure-lowering drugs). As such, in recent years there has been a concomitant increase in the number and volume of prescription medications dispensed nationwide. Studies have also reported that younger Americans are taking more medication than ever before, though the basis for this trend is less apparent. Prescription medication is typically dispensed to individuals in person at local pharmacies or administered in a hospital setting. In recent years, some healthcare companies have started offering mail order systems, allowing patients to have some types of medication delivered directly to their homes.

Related to this point, in recent years several states have formally recognized the medicinal benefits of marijuana has been limited due to legal and logistical issues. For example, neighboring states may have conflicting policies regarding the legality of marijuana, causing individuals in the more restrictive state to cross the border to obtain prescriptions and access. These state-level discrepancies have created legal and logistical issues limiting the cultivation, transport and distribution of medicinal marijuana. In particular, limited options exist for efficiently and securely transporting medicinal marijuana from growers (and/or distribution centers) to authorized dispensaries. Insecure shipments may be lost, stolen, or redirected to a different jurisdiction.

### BRIEF SUMMARY

In view of the shortcomings of current transport options, there exists a need in the art for new and improved storage vessels that can be used for securing and transporting medication, and in particular, storage vessels suitable for securing and transporting controlled substances (e.g., opioid painkillers and medicinal marijuana).

The present disclosure addresses these needs by providing devices that can be used to secure a storage vessel (e.g., a container or bottle), as well as secure storage vessels that can optionally be tracked and/or monitored using a radio frequency (RF) or other wireless tagging systems. In some aspects, devices according to the disclosure comprise a cap configured to seal a container, wherein the cap comprises an outer housing containing a processor configured to execute programmable logic; a sensor capable of detecting and/or measuring one or more parameters and transmitting a signal to the processor based on the detected and/or measured parameters; and an adulterant dispenser, configured to produce and/or release an adulterant when the sensor detects and/or measures a level of a parameter that meets or exceeds a pre-set threshold. Other exemplary embodiments described herein include secure storage vessels comprising a container which includes an adulterant that may be triggered to release when one or more conditions are met, rendering any medication (or other controlled substance) in the container unusable or at least undesirable to an end user. Such vessels may also provide additional benefits, as explained herein, e.g., more efficient tracking and inventory management.

In some exemplary aspects, the disclosure provides a secure storage vessel, comprising: a container and a lid, wherein the lid is configured to attach to the container; one or more sensors, positioned within the container; a lock, incorporated into the lid; a reservoir, positioned within the container and configured to hold an adulterant; a piercing means, positioned within the container and configured to release the adulterant from the reservoir in response to a signal generated by the lock and/or the sensor. In some aspects, the lid is further configured to form an airtight seal when attached to the container. In some aspects, at least one of the one or more sensors comprises: an air pressure sensor, a temperature sensor, a humidity sensor, or any combination thereof. In some aspects, the lock comprises a mechanical lock or an electronic lock. In some aspects, the piercing means comprises a spring-loaded pin or blade. The adulterant may comprise, e.g., a dye, a bitter-tasting compound, a foul-smelling compound, or any combination thereof. Furthermore, the secure storage vessel may further comprise one or more of a radio frequency identification (RFID) tag or a global positioning system (GPS) sensor. In some aspects, the sensor comprises an air pressure sensor configured to activate the piercing means when a pressure level in the secure storage vessel meets or exceeds a threshold level. The container may comprise, e.g., a bottle, a canister, or any other type of storage vessel.

In some aspects, the disclosure further provides systems and methods for using the secure storage vessels described herein, and for distributing controlled substances generally. For example, a method for transporting a controlled substance may comprise: placing the controlled substance in any secure storage vessel described herein; locking the secure storage vessel; transporting the secure storage vessel to a new location; and optionally, opening the secure storage vessel. In some aspects, such methods may further comprise reducing the air pressure level in the secure storage vessel after placing the controlled substance in the secure storage vessel, wherein the sensor comprises an air pressure sensor and the lid is configured to form an airtight seal when attached to the container.

In other aspects, the disclosure provides methods for storing and/or transporting an item, comprising: placing the item into a container, attaching a cap comprising one or more sensors and a means for adulterating the contents of the container when triggered by a signal produced by the sensor. Such methods may further comprise locking the cap onto the container, and/or transporting the container. The cap may comprise one or more sensors configured to detect and/or measure one or more environmental or other parameters (e.g., pressure or humidity within the container, time elapsed since the cap was placed into contact with the container, GPS coordinates, or an electromagnetic signal).

In some aspects, the disclosure provides devices for securing a container, comprising: a cap configured to seal a container, wherein the cap comprises (a) an outer housing containing a processor configured to execute programmable logic; (b) one or more sensors capable of detecting and/or measuring one or more parameters and transmitting a signal to the processor based on the detected and/or measured parameters; and (c) an adulterant dispenser, configured to produce and/or release an adulterant; wherein the processor is programmed to trigger production and/or release of the adulterant, by the adulterant dispenser, when the one or more sensors detect and/or measure a level of a parameter that meets or exceeds a pre-set threshold.

In some aspects, the cap is adapted to seal a container using a threaded interface. The adulterant dispenser may be (a) integrally attached to the outer housing; or (b) detachably attached to the outer housing. Similarly, the one or more sensors may be integrated into or attached to the outer housing, or alternatively separate from and communicatively linked to a microcontroller or circuitry in the outer housing (e.g., via a wireless connection). In some aspects, the sensor is configured to detect and/or measure: (a) a level of air pressure; (b) a level of humidity; (c) a radio frequency or electromagnetic signal; and/or (d) GPS coordinates. In some aspects, the cap further comprises a locking mechanism configured to secure the cap to the container when in a locked state, and to allow removal of the cap when the locking mechanism is in an unlocked state. In some aspects, the processor may be programmed not to trigger production and/or release of the adulterant, by the adulterant dispenser, when the locking mechanism is in the unlocked state. Moreover, the locking mechanism may be a mechanical lock that can be switched into a locked or unlocked state using a physical key, a key code, or a wireless signal. In some aspects, the adulterant may comprise one or more of the following: (a) a dye; (b) a foul-tasting compound; (c) a foul-smelling compound; (d) a compound that forms a foam when released, at a volume sufficient to fill the container upon release; or (e) heat, light, and/or electromagnetic radiation.

This simplified summary of exemplary aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and particularly pointed out in the claims.

### BRIEF DESCRIPTION OF THE FIGURES

The accompanying drawings, which are incorporated into and constitute a part of this specification, illustrate one or more example embodiments of the invention and, together with the detailed description serve to explain their principles and implementations.

FIG. 1 shows a side perspective view of a secure container according to an exemplary aspect of the disclosure.

FIG. 2 shows a side perspective view of a trap mechanism according to an exemplary aspect of the disclosure.

FIG. 3 shows a side perspective view of an adulterant pod according to an exemplary aspect of the disclosure.

FIG. 4A shows a side view of a device for securing a storage vessel according to the disclosure.

FIG. 4B shows a cross-sectional view of the device shown in FIG. 4A.

FIG. 5A shows a side view of the device shown in FIG. 4A attached to a container.

FIG. 5B shows a cross-sectional view of the device and container shown in FIG. 5A.

FIG. 6A shows a top view of the device and container shown in FIG. 5A, with the outer housing of the device partially removed.

FIGS. 6B-6C show side views the device and container shown in FIG. 6A.

### DETAILED DESCRIPTION

Secure storage vessels, and related devices that can be used to secure a storage vessel (e.g., a container or bottle) suitable for securing and/or transporting controlled substances (e.g., prescription medication and medicinal marijuana) are described herein, as well as systems and methods for using the same. The following description includes references to the accompanying drawing. In the drawings, the same reference numeral is used to represent the same part or a corresponding part so as to avoid repeated explanation. Those of ordinary skill in the art will realize that the following description is illustrative only and is not intended to be in any way limiting. Other aspects will readily suggest themselves to those skilled in the art having the benefit of this disclosure.

In some exemplary aspects according to the disclosure, a secure storage vessel comprises a container and a corresponding lid, a lock configured to control the release of the lid from the container, an adulterant stored within a sealed compartment within the container, and a mechanism configured to open the sealed compartment when activated (e.g., a “trap” as used herein), allowing the adulterant stored within to enter into the remaining portion of the container. In some exemplary aspects, the secure storage vessel further comprises a sensor configured to activate a trap provided within the secure storage vessel when at least one condition is satisfied. In some exemplary aspects, the trap may be configured to activate (or deactivate) based upon a mechanical interaction with the lock (e.g., the trap may be placed into a deactivated state when the correct key is placed into the lock or when a correct combination number is selected). In still further aspects, the trap may be configured to activate (or deactivate) based upon an electronic or wireless signal. The signal may be provided, e.g., by an electronic component associated with the lock or an RF signal provided from an external source.

Secure storage vessels according to the disclosure may be used, e.g., to store and transport controlled substances (e.g., prescription pharmaceuticals or medicinal marijuana). Such vessels may be advantageously used to prevent the loss or theft of controlled substances in transit to pharmacies, dispensaries, or other storage/distribution centers, by ensuring that the contents stored within are only accessible at certain locations or to certain entities that can unlock the container without causing the adulterant to be released. In some aspects, the adulterant comprises a dye, a foul-smelling substance, a bitter-tasting substance, or any combination thereof, intended to render the contents of the vessel undesirable or unusable. For example, secure storage vessels used to store an opioid medication may include an adulterant comprising a naloxone solution. Naloxone blocks the effects of opioid medications, and so the release of the naloxone solution into the container would render the opioid medication stored within unusable. The added difficulty associated with gaining access to the opioid contents stored with the vessel may reduce incidents of theft, and consequently, incidents of opioid misuse.

As noted above, in some exemplary aspects a secure storage vessel may comprise one or more sensors. Each sensor may be configured to measure, determine or detect one or more environmental conditions and/or parameters. For example, a sensor may be configured to measure air pressure, temperature, or humidity, within the vessel. In some aspects, a sensor may be configured to measure the location of the vessel (e.g., using GPS). In still further aspects, a sensor may be configured to measure or detect the distance that the vessel has traveled, the speed at which the vessel is traveling (e.g., detecting a sudden movement), or a current date and/or time. Sensors may also be configured to interact with a lock located in the lid of a container, either directly (e.g., via a mechanical means) or indirectly (e.g., via an electronic signal provided by a module associated with the lock). For example, a sensor may be configured to determine when an incorrect key is inserted into the lock or when an incorrect combination is selected. The sensor may also detect and/or measure a number of times that an incorrect key or code has been used, in total or within any arbitrary timespan. In some aspects, a sensor may be configured to detect a wireless signal (e.g., provided by an RF tag integrated into the lid associated with a container, allowing the sensor to determine whether the lid has been removed from the container). The wireless signal may also be provided by an external source (e.g., a device at an authorized pharmacy or dispensary may provide a RF or other wireless signal detectable by the sensor).

In some aspects, a sensor provided within, on, or in proximity to the vessel may be configured to activate a trap within the container, causing an adulterant to be released from a sealed compartment within the container. For example, the lid of the container may include a port allowing one to remove air from the container after contents have been added, creating an airtight (or otherwise pressurized) environment. An air pressure sensor may be used to detect whether the lid has been removed, or if the container has otherwise been ruptured, based upon a change in the measured air pressure within the container. This sensor may also be configured to activate a trap when a given air pressure threshold is detected. In order to prevent this air pressure sensor from inadvertently causing the adulteration of contents when the container is opened by an authorized entity, the container may further include a mechanical or electronic mechanism associated with the lock that prevents the trap from activating. For example, a mechanical mechanism may deactivate the trap when a correct key is inserted into the lock, negating or preventing the activation signal sent by the air pressure sensor when the lid is removed).

It is understood that this general principle may be applied to any of the embodiments described herein, e.g., the secure storage vessels and devices for securing a storage vessel described herein may include a mechanism (e.g., in a lock, lid/cap, or elsewhere) that prevents the trap(s) incorporated into the vessel from activating under at least one condition (e.g., when a correct key is used), preventing or negating an activation signal generated or otherwise provided by a sensor associated with the vessel. This principle is necessary in some embodiments to ensure that authorized entities have at least one means for opening the secure storage vessel without triggering adulteration of the contents stored within the vessel.

As described herein, a secure storage vessel according to the disclosure may comprise a lid (or cap), the size of which being dependent on the size of the corresponding container. In some aspects, the container and lid may be composed of an airtight material. The inside and/or outside may be further coated with a sealant to ensure an airtight seal is present. In some aspects, the vessel is preferable formed from durable material(s) which are shatter and/or puncture-resistant. In order to provide a secure, airtight seal, the vessel may comprise top, bottom, and/or sidewalls with a thickness of at least 0.25″, 0.5″ or 0.75″. In some aspects, the lid or cap may include a nozzle or other port capable for use in vacuum sealing the vessel after the lid or cap is affixed. For example, the port may comprise an aperture that can be selectively opened or closed after the lid or cap is affixed to the corresponding vessel, e.g., allowing a technician to vacuum air out of the vessel after the contents have been added. This port may thus be used to create a vacuum, near-vacuum, or otherwise pressurized environment within the vessel.

A cap or lid of the vessel may be configured to include a flat space on the top which is large enough to affix a tracking tag. These tracking tags may be used to link with existing or future serialization, custody chain, logistics, and inventory systems (e.g., in order to label each vessel and to key each vessel to an authorized user). These tags may come in any technically-feasible form including though not limited to: bar code(s), RF-identification, or optically-scanned tags/codes. Similarly, any such tracking tags may be incorporated into the container or another component of the vessel.

As described herein, a cap or lid of a vessel according to the disclosure may comprise at least one lock. This lock may be configured to open using a key mechanism. The key mechanism may be mechanical (e.g., a physical key, a combination code), electronic (e.g., a fingerprint reader, a time-release mechanism, a mechanism unlocked by an RF or other wireless signal), or any combination thereof. This lock and key mechanism may be used, e.g., to ensure that a cap or lid can be “unlocked” for authorized users, disabling all traps prior to opening. As such, in some aspects a lock is configured to directly or indirectly interact with one or more trap(s) located in the container. This interaction may be performed via an intervening mechanical mechanism, a wireless mechanism, or any combination thereof, which is engaged when the lock is opened by an intended key mechanism.

In some aspects, the lock incorporated into a vessel according to the disclosure may comprise a security mechanism configured to activate one or more traps positioned within the container upon unauthorized entry or attempted entry, without physically locking the cap or lid onto the container. To illustrate this point, a lock may comprise a security mechanism built into a lid of a vessel which triggers release of an adulterant if the lid is removed at an unauthorized time or at an unauthorized location, without including any physical means for preventing one from opening the vessel (e.g. the lid may be secured to the container by a simple threading interface).

The one or more sensors included in the container, as noted above may measure or detect pressure, or any other environmental or other parameter. Such sensor(s) may be affixed or fused to the inside wall(s) of the container and/or lid. In some aspects, sensors may be affixed in the following pattern: (a) one sensor, affixed to a point located at least 10%, 20%, 30%, 40% or 50% from the bottom of the vessel as measured along the vertical axis; (b) two sensors, one affixed to an upper wall of the vessel directly under a cap or lid and the other affixed to a vessel sidewall at least 10%, 20%, 30%, 40% or 50% from the bottom of the vessel as measured along the vertical axis, each of which optionally being centered on different axes; three sensors, one affixed to an upper wall of the vessel directly under the lid, the second affixed to a point at least 10%, 20%, 30%, 40% or 50% from the bottom of the vessel as measured along the vertical axis, and the third affixed directly to a bottom wall of the vessel. It is understood that it other embodiments, the one or more sensors may be attached or otherwise incorporated into any internal or external surface of a secure storage vessel according to the disclosure.

In some aspects, at least one of the sensors included in a secure storage vessel may be configured to operate in two modes: a “breach” mode and an “active” mode. In some aspects, breach mode occurs when one of the following conditions is met: (a) the lid or cap is opened as directed; (b) the pressure level in a vacuum-sealed vessel exceeds or reaches a selected threshold indicative of a puncture or other substantial breach of the vacuum seal, or which indicates that the vessel is being stored in an unsafe manner that may affect its contents (e.g. air pressure changes as the bottle gets very hot, which, if holding pills, would suggest improper and possibly unsafe storage conditions); (c) when a key mechanism is unsuccessfully engaged beyond a threshold number of times (e.g., indicating that an entity may be attempting to pick or otherwise bypass the lock). At all other times, the sensor may operate in active mode, wherein at least one environmental parameter is being measured, detected, and/or determined. Each sensor may have the capability to be manually reset from breach to active mode.

As noted above, one or more of the sensors in the container may have a mechanical or electronic connection (directly or indirectly) to one or more traps positioned within the container. For example, in some aspects, a sensor may be mechanically connected to a spring slide element of a trap. When a physical breach occurs, causing a sensor to switch into breach mode, the sensor may trigger activation of the spring on the spring slide, resulting in a rupture of a sealed compartment containing an adulterant. In some aspects, the sealed compartment may comprise an adulterant pod (e.g., a sealed pod or other container containing at least one solid or liquid adulterant). For example, the spring slide may be configured such that a firing event pushes an adulterant pod against a sharp protrusion, breaking the seal on the adulterant pod and dispersing the adulterant throughout the vessel.

In some alternative aspects, the secure storage vessel is a large vessel capable for use in transporting bulk pharmaceuticals from compounding facilities to pharmacies. The secure storage vessel, in this case, may include a scale sensor (e.g., an electronic scale incorporated into the bottom of the vessel). After the vessel is loaded, closed, and optionally vacuum sealed, the weight may be recorded by the scale sensor. In some aspects, the scale sensor may be further configured to interact with a mechanical, combination, or digital lock incorporated into the exterior of the vessel. The scale sensor may be configured to have three states, “locked,” “triggered,” and “disarmed.” The sensor may be locked for transit, e.g., by entering a particular combination into the lock/digital lock, or by closing a lid or cap of the vessel. Once in the locked state, the scale sensor may be activated (causing a transition to the triggered state) if the weight inside the vessel changes between when the vessel is locked and disarmed, or after multiple failed attempts to disarm the sensor (in-transit tampering being the primary cause of illegal siphoning of pharmaceuticals). A scale trap provided in the vessel may be configured to release an adulterant when the scale sensor enters the triggered state. In some aspects, the scale sensor may be disarmed when a designated recipient enters an authorized combination into the lock (e.g., after the vessel is delivered). In this disarmed state, the scale trap is prevented from or otherwise unable to activate.

Another exemplary embodiment of a secure storage vessel according to the disclosure includes a smaller system that can installed within a vessel designed by a third party as packaging (e.g., for cosmetics and beauty products typically sold by boutiques that wish to prevent out-of-boutique unauthorized sales). In this embodiment, the sensor cannot be reset, and may be placed directly beneath the lid or cap of a container to be as unobtrusive as possible. In some aspects, this embodiment is intended for single-use.

As described herein, a secure storage vessel according to the disclosure may comprise one or more traps configured to cause the release of adulterant within the container of the vessel when activated. In some aspects, a trap comprises a sealed compartment containing a solid or liquid adulterant (e.g., an adulterant pod), a piercing member capable of puncturing or tearing the sealed compartment, and at least one spring or other actuator that causes the piercing member to open the sealed compartment when triggered.

For example, in some aspects, a trap may comprise a “reservoir,” a “spring slide” and an “aperture” as described below. The reservoir may be an empty space within the vessel sized to snugly contain a single adulterant pod, optionally with a small amount of additional space available at one end. This reservoir may be formed as any shape, e.g., cube-shaped. In some embodiments, the reservoir may alternatively be structured as a balloon or bladder comprising a flexible membrane and containing an adulterant. To be clear, while the description that follows refers to areas of a cube-shaped reservoir, it is expressly understood that this description is a non-limiting example and that any suitable shape may be used. In this example, the far face of the cube-shaped reservoir is the interior vessel wall. The near and both side faces of the cube may be constructed of a hard and non-porous plasticine material. The reservoir may be capable of being filled with an adulterant pod comprising at least one liquid or solid adulterant. The bottom face of the cube-shape reservoir, in this example, is referred to as the “aperture.” The aperture may comprise a fine mesh with the following qualities: (a) it may be sufficiently porous to allow any type of adulterant to pass through; (b) holes in the mesh may be distributed in a manner that disperses any liquid passing through it in as wide a stream as possible (as in a watering can or the soak function on a garden hose); and (c) the center of the aperture may contain a hard and/or sharp, protrusion which optionally tapers to a point (e.g., a piercing member). In this particular example, the aperture is presumed to be downward-facing. However, the orientation of a trap may be adjusted and may be configured to function in any arbitrary direction as is suitable for a given container and/or reservoir).

The top face of the cube-shaped reservoir may be referred to as the “spring slide” This spring slide may have one or more of the following components: (a) a hinge with a door that opens vertically, as a trap door; (b) a protrusion from the door that acts as an outside-facing latch to open the door; (c) a spring on the bottom, inward-facing side of the door, that loads when the trap door is closed; and (d) a (direct or indirect) connection to a sensor. Whenever the connected sensor registers a breach, the spring on the bottom of the door fires with sufficient force to propel the adulterant pod against the sharp protrusion in the aperture, puncturing the pod and dispersing its contents through the vessel. The door noted in element (a) above allows the reservoir to be reloaded with another adulterant pod for re-use after an activation.

In some aspects, a small hinge may be positioned directly below the aperture that allows the door to move from its vertical (or open) to horizontal (or closed) positions and vice-versa. This hinge may be attached to a small door which functions as a trapdoor and allows for the door to move between its vertical (open) and horizontal (closed) states. In some aspects, the hinge features a mechanical connection to the lock and/or key mechanism. The door may comprise a thin piece of a hard and non-porous material with a very slight raise along the edge. In some configurations, the door begins in a vertical (open) state, reminiscent of an open attic door or an open trapdoor on a theater stage. If the vessel is successfully unlocked by a key mechanism, then the floor flips up to its horizontal (closed) state. When in this horizontal (closed) state, the door completely covers the aperture, preventing the contents of the adulterant pod from entering the rest of the vessel.

As noted above, in some exemplary aspects, a trap may be configured as a scale trap. In some aspects of this alternative configuration, the trap may comprise: a) an adulterant reservoir affixed to the bottom of the vessel (“base trap”) and to a position located directly below the lid (“top trap”). The base trap may comprise of a thin layer at the bottom of the vessel, with an opening at the top covered by a covering element (e.g., the floor of the vessel, covering the adulterant reservoir). The covering may be non-porous but thin enough to be easily and/or wholly punctured by the force from a spring-propelled piercing element or other spring-based mechanism. In some aspects, this trap may include a small spring mechanism underneath the reservoir. In some aspects, when the scale trap is triggered, this spring uncoils and launches the contents of the base trap into the container (gravity acting as a propellant for the trap). The scale trap may also include refuel points and/or any of the sensors described herein.

As described herein, a secure storage vessel according to the disclosure may comprise one or more solid or liquid adulterants. The nature of the adulterant may differ based on the contents of the vessel. However, in some aspects the adulterant may comprise a liquid that a) stains the contents of the vessel; and/or b) denatures or otherwise defeats the intended use of the contents of the vessel. For example, an adulterant may comprise: (a) a black and/or viscous dye (e.g., for beauty or skincare products); (b) a foul-smelling substance (e.g., for perfumes and shampoos); (c) a naloxone-containing solution (e.g., for opioid products); or a non-toxic but foul-smelling-and-tasting liquid (e.g., for marijuana or luxury food products).

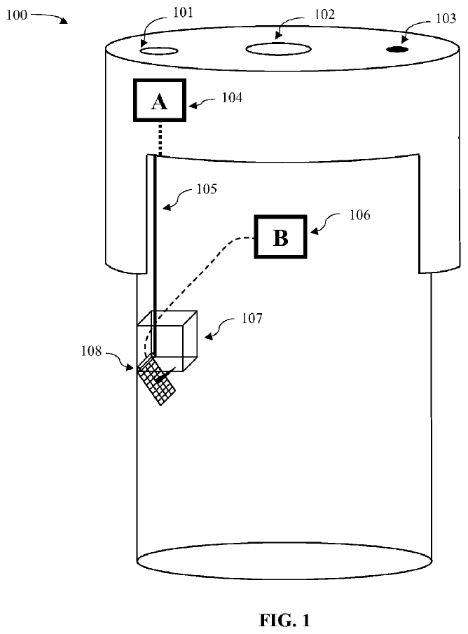

FIG. 1 illustrates an exemplary secure storage vessel 100 according to the disclosure. As illustrated by this exemplary embodiment, a secure storage vessel 100 may comprise a container 100a and a detachable lid 100b. The lid 100b may include a keyhole 101, an RFID tag 102, and an opening or port 103 (e.g., configured to allow a user to vacuum-seal the container 100a). The lid 100b may incorporate a lock mechanism 104 (also labeled as element “A”). This lock mechanism 104 may be a mechanical or digital locking mechanism. In this example, a mechanical lock is shown (e.g., which cooperates with a key inserted in the keyhole 101). The lock mechanism 104 may be configured to activate/deactivate a trap 108 in the container 100a via a mechanical or electronic mechanism. In this example, a simplified mechanical mechanism is illustrated in the form of a rod 105 configured to mechanically interact with and activate the trap 108. A sensor 106 (also labeled as element “B”) may be included in the container 100a. This sensor 100a (e.g., an air pressure sensor) may be mechanically or otherwise communicatively linked to the trap 108. In this example, the sensor 106 is an air pressure sensor capable of activating or deactivating the trap 108 depending on the air pressure level detected in the container 100a. The trap 108 in this example comprises a piercing element (e.g., a blade or pin) positioned on a spring-loaded hinge. A reservoir 107 is located in proximity to the trap 108, and configured to hold an adulterant pod. Upon activation (e.g., by the lock mechanism 104 or the sensor 106), the spring-loaded piercing element shifts position, causing the piercing element to rupture the adulterant pod, allowing its contents (e.g., a solid or liquid adulterant) to release into the container 100a. In some aspects, the trap 108 may be deactivated by the lock mechanism 104 or the sensor 106, allowing a user to safely open the secure storage vessel 100 under certain conditions.

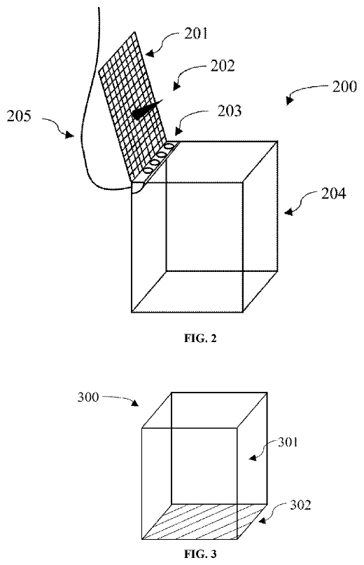

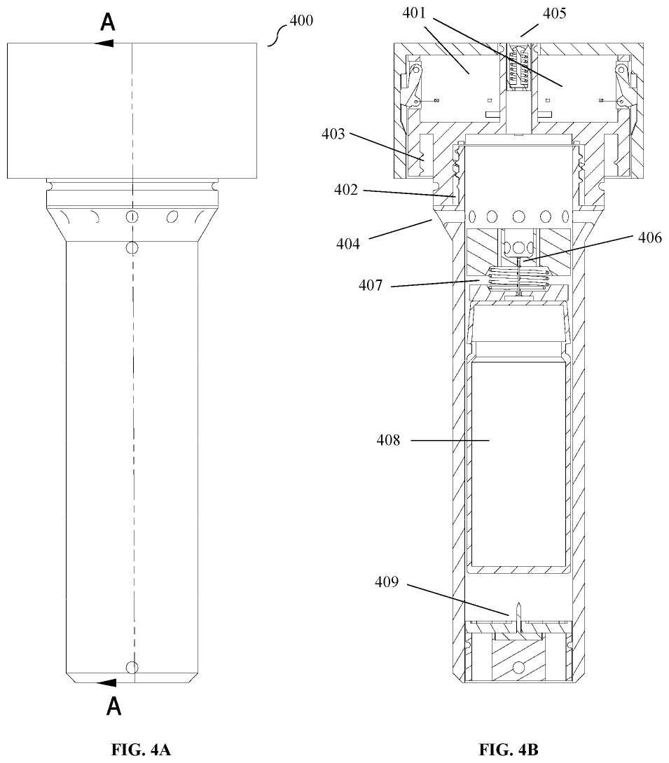

FIGS. 2 and 3 illustrate representative examples of a trap 200 and an adulterant pod 300, respectively. As shown by FIG. 2, a trap 200 may comprise a solid support 201 which includes a piercing element 202 (e.g., a sharp pin or similar structure). The solid support 201 may be have a porous structure (e.g., capable of allowing a liquid adulterant to pass through the solid support 201). The solid support 201 may be attached to a reservoir 204 via a spring-loaded hinge 203. An intervening mechanical or electronic element 205 (in this case a wire) may physically connect and/or operatively link this spring-loaded hinge 203 with a lock mechanism 104 or sensor 106 included as part of the secure storage vessel 100. This mechanical or electronic element 205 may be configured to activate/deactivate the spring-loaded hinge 203 (e.g., causing the solid support 201 to shift position when activated). The reservoir 204 may be configured to store an adulterant (e.g., an adulterant pod 300). As shown by FIG. 3, the adulterant pod 300 may comprise a cubic shape (or any other desired shape). The adulterant pod may comprise one or more sidewalls 301. In this example, a one sidewall 302 is configured to be easily pierced (e.g., by having a thinner thickness compared to the other sidewalls 301).

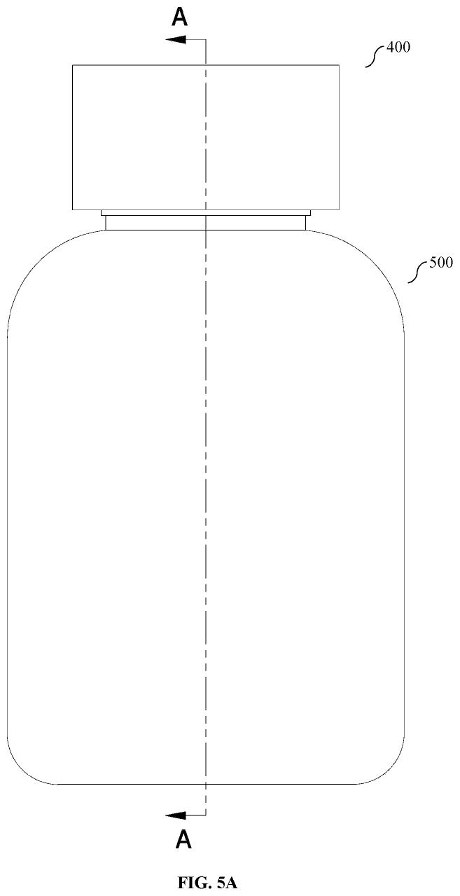

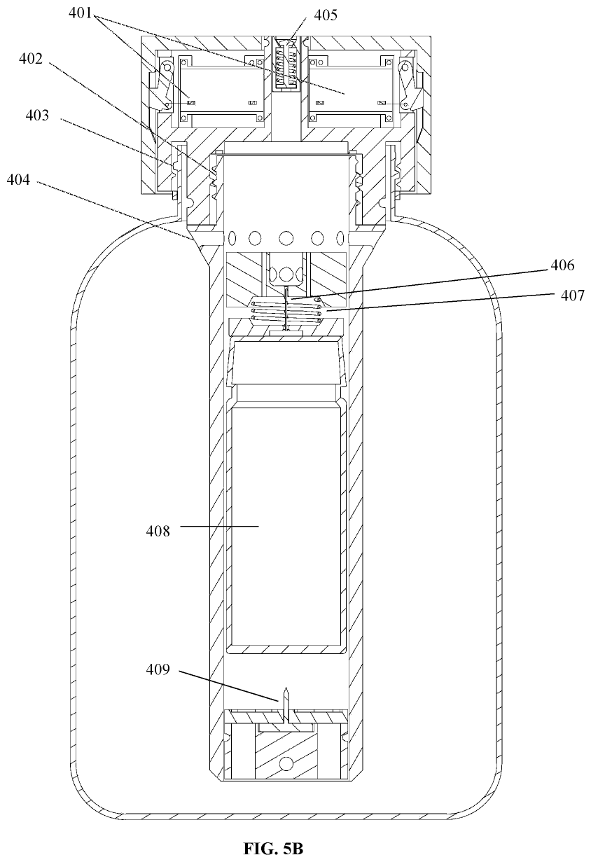

In some aspects, the disclosure provides devices that can be inserted into or onto a container (e.g., incorporated into or as a cap or plug), to secure the contents of said container. Such devices may optionally incorporate any of the elements or perform any of the functions described herein (e.g., any of the sensors described herein). FIGS. 4A and 4B illustrate an exemplary embodiment of one such device 400. FIG. 4A is a side view showing the outer housing of the device 400 and FIG. 4B is a cross-sectional view of the device 400. In this example, the device 400 is substantially cylindrical in shape, with a cap subassembly at one end and a tubular member extending away from the cap subassembly along a longitudinal axis of the device 400. The tubular member may be adapted to contain or hold an adulterant cartridge and a mechanism that may be used to trigger release of the adulterant (e.g., by puncturing the adulterant cartridge 408 in response to a signal from a sensor integrated into or attached to the cap subassembly. In this example, the tubular member and cap subassembly are separate elements that may be connected using complementary threading present on both components (as shown in FIG. 5B). In other embodiments, the cap subassembly may be integrally attached to the tubular member. It is further understood that any arbitrary shape may be used for the outer housing of the device 400 as desired to fit into or onto a given container, bottle, or other storage vessel in order to seal said vessel. For example, the tubular member used in this exemplary embodiment may be replaced by a more compact (e.g., non-tubular) shape in alternative embodiments, while retaining the functionality of the tubular member described herein.

FIG. 5A is a side view showing a container 500 sealed by the device 400. FIG. 5B is a cross-sectional view of the sealed container shown in FIG. 5A. As illustrated by this figure, the device 400 may comprise one or more cap lock actuators 401 (e.g., in the cap subassembly), which control a locking mechanism used to affix the device 400 to a container 500. For example, the cap lock actuators 401 may comprise an electronic circuit or microcontroller, a battery, one or more motors, and/or one or more sensors (e.g., a pressure sensor). The cap lock actuators 401 may be configured to allow the device 400 to be locked onto a container 500 and released under specified conditions, without triggering the release of an adulterant stored within the device 400. In some embodiments, the cap lock actuator 401 may comprise a microcontroller configured to operate a motor that switches a mechanical locking mechanism into an activated or deactivated stated based upon a signal detected by one or more sensors. For example, the cap lock actuator 401 may include a radio frequency sensor, an electromagnetic sensor, and/or a GPS sensor, and may be configured to lock or unlock the container 500 in response to specific RFID signals or when in proximity to certain GPS coordinates. The cap lock actuator 401 may alternatively be programmable (e.g., configured to activate or deactivate a mechanical locking mechanism at a specific time). In some embodiments, the cap lock actuator 401 may comprise a pressure sensor. The cap lock actuator 401 may be configured to activate a mechanical lock when the internal pressure within the container 500 is above or below a given threshold. For example, the device 400 may be attached to a container 500, which is then subjected to vacuum to reduce pressure within the container 500, causing the cap lock actuator 401 to activate a mechanical lock. In some aspects, the cap lock actuator 401 may be configured to control the pressure in the container 500. For example, the cap lock actuator 401 may comprise a microcontroller configured to operate a motor or valve that allows gas to enter or leave the container (e.g., when the cap lock actuator 401 is placed into a deactivated state in response to a pre-set signal). An exemplary pressure release valve 405 is shown in FIG. 4B.

The device 400 may also comprise a first threaded interface 402 for connecting the cap subassembly to the tubular member, a second threaded interface 403 for connecting the cap subassembly to the container 500, and one or more vent holes 404 which allow fluid communication between the adulterant stored in the adulterant cartridge and the inside of the container 500, when the device 400 is triggered to release the adulterant (e.g., by a pressure sensor incorporated into the device 400, which is communicatively linked to the cap lock actuator 401).

For example, in some embodiments the cap lock actuator 401 may comprise circuitry or a microcontroller configured to receive signals from a pressure sensor incorporated into the device 400 (e.g., in the cap subassembly). The microcontroller may be configured to trigger release of an adulterant stored within an adulterant cartridge 408 contained in the tubular member in response to a signal from the pressure sensor (or any other sensor incorporated into the device 400). In the exemplary device 400 shown in FIG. 5B, the tubular member contains an adulterant cartridge 408 which is attached to an inner surface of the tubular member by a fusible link 406. A coil spring 407 is placed between the adulterant cartridge 408 and this inner surface, and maintained in a compressed state due to the presence of the fusible link 406. The cap lock actuator 401 is configured to cause the fusible link 406 to melt when triggered by a pre-set signal (e.g., when a communicatively-linked pressure sensor detects that pressure has increased within the container 500, while the lock is in an active state). With the fusible link 406 melted, the coil spring 407 is free to extend, causing the adulterant cartridge 408 to quickly shift downward along the axis of the tubular member. As shown by FIG. 5B, a pin, blade, or other piercing member 409 may be placed within the tubular member (e.g., on a surface opposite the coil spring 407). In this example, the adulterant cartridge 408 is pierced by the aforementioned piercing member 409 upon activation of the coil spring. The adulterant stored within the adulterant cartridge 408 is then released and can enter the container 500 through the one or more vent holes 404. In some embodiments, the adulterant cartridge 408 may be pressurized and/or may include one or more propellants (e.g., to increase the rate of transmission of the adulterant into the container 500).

In some aspects, the adulterant cartridge 408 may comprise a sealed compartment or vial containing an adulterant (e.g., a dye, or a chemical compound that imparts a foul taste or smell). In some aspects, the adulterant may comprise a chemical compound capable of filling the container upon release (e.g., a the adulterant cartridge 408 may contain a compound stored under pressurized conditions, which converts to a gas or foam when depressurized, filling all or substantially all of the container). For example, in some aspects the adulterant cartridge 408 may contain hydrogen peroxide and the tubular member may also include a catalyst (e.g., potassium iodide solution and/or catalase), wherein the hydrogen peroxide is placed into contact with the catalyst when the device 400 is triggered (e.g., by a pressure sensor). The resulting chemical reaction would then cause the hydrogen peroxide to rapidly expand in volume, creating a foam which passes through the one or more vent holes 404 into the container 500.

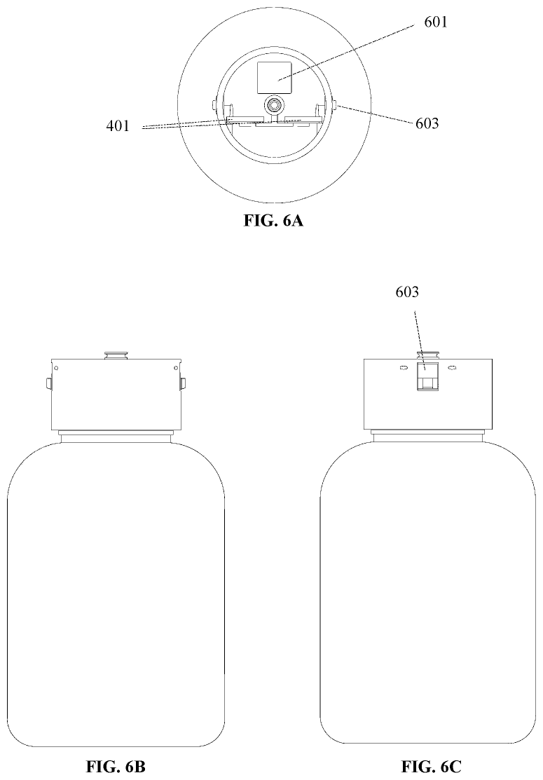

FIGS. 6A-6C show alternative views of the device 400 attached to a container 500, with the shell surrounding the outer housing of the device 400 removed. As shown by FIG. 6A, the cap subassembly of the device 400 may comprise a pressure sensor 601, cap lock actuators 401, and one or more cap lock toggles 603.

In some exemplary embodiments, the disclosure provides secure storage vessels that comprise a container (e.g., a bottle, canister, or other vessel), a cap, and an adulteration means configured to chemically or physically modify one or more items stored within the vessel when triggered (e.g., by a sensor integrated into the cap). For example, the adulteration means may be configured to produce heat, light, and/or electromagnetic radiation, or to release a caustic agent, when triggered. For example, the adulteration means may comprise one or more heating elements, electromagnetic elements, or light sources (e.g., light-emitting diodes). In some exemplary aspects, the adulteration means is integrated into the cap. In others, it may comprise a separate element attachable to the cap and/or to an inner surface of the container. Such embodiments may be advantageous for applications where a modular system is desired (e.g., allowing for different adulteration means to be selected as desired based upon the intended contents of the container). It embodiments according to this exemplary aspect, the cap may comprise any of the elements of cap subassemblies described herein. For example, the cap may comprise one or more sensors configured to detect and/or measure a parameter (e.g., the internal pressure within the container), and one or more locking mechanisms configured to lock or unlock the cap (e.g., in response to a mechanical key, a key code, or a wireless signal). The cap may also comprise a microcontroller or circuitry which controls any such mechanisms or functions. The cap may also comprise an opening or vent that may be used to remove gas from the container after the cap is attached (e.g., allowing the container to be depressurized or pressurized after the cap is affixed and/or placed into a locked state. For example, the cap may comprise a microcontroller configured to receive a signal from a pressure sensor integrated into the cap and positioned such that the sensor is capable of detecting and/or measuring the level of air pressure within the container. The microcontroller may be configured to activate the adulteration means if the pressure sensor indicates that the air pressure is above or below a pre-set pressure while a locking mechanism integrated into the cap is in a locked state. The microcontroller may be configured not to activate (or to deactivate) the adulteration means if the locking mechanism is in an unlocked state (e.g., when the cap is unlocked for removal by an authorized user).

It is understood that the secure storage vessels described herein may be used as part of a method or system for storing and/or transporting items (e.g., controlled substances, medicine, valuables). In some aspects, a method for securing and/or transporting a controlled substances may comprise: placing the controlled substance in any of the secure storage vessels described herein, and sealing the vessel. In some aspects, the method may further comprise pressuring or depressurizing the vessel after the sealing step, transporting the vessel to a different location, and optionally, opening the vessel.

In some aspects, the disclosure provides methods for storing and/or transporting an item, comprising: placing the item into a container, attaching a cap comprising one or more sensors and a means for adulterating the contents of the container when triggered by a signal produced by the sensor. Such methods may further comprise locking the cap onto the container, and/or transporting the container. The cap may comprise one or more sensors configured to detect and/or measure one or more environmental or other parameters (e.g., pressure or humidity within the container, time elapsed since the cap was placed into contact with the container, GPS coordinates, or an electromagnetic signal). In some aspects, the cap may include a microcontroller or circuitry configured to trigger release and/or production of an adulterant within the container, in response to a signal generated by the one or more sensors. In some aspects, the cap may incorporate a locking mechanism that can be activated or deactivated in response to a mechanical or electronic key or key code, or in response to a particular signal (e.g., an RFID signal). In some aspects, the microcontroller or circuitry which controls the adulteration means may be configured not to activate the adulteration means when the locking mechanism is in a deactivated state (e.g., an authorized user may deactivate the locking mechanism, allowing for the cap to be removed without adulterating the contents of the container).

In the interest of clarity not all of the routine features of the aspects are disclosed herein. It is understood that in the development of an actual implementation of the present disclosure, numerous implementation-specific decisions must be made in order to achieve specific goals (e.g., secure storage vessels may be configured differently based upon the type of material to be stored), and that these specific goals will vary for different implementations. It will be appreciated that such a efforts might be complex and time-consuming, but would nevertheless be a routine undertaking of engineering for those of ordinary skill in the art, having the benefit of the present disclosure.

Furthermore, it is understood that the phraseology or terminology used herein is for the purpose of description and not of restriction, such that the terminology or phraseology of the present disclosure is to be interpreted in light of the teachings and guidance presented herein, in combination with knowledge available to a person of ordinary skill in the relevant art(s) at the time of invention. Moreover, it is not intended for any term in the specification or claims to be ascribed an uncommon or special meaning unless explicitly set forth as such in the specification.

The various aspects disclosed herein encompass present and future known equivalents to the structural and functional elements referred to herein by way of illustration. Moreover, while various aspects and applications have been shown and described herein, it will be apparent to those skilled in the art having the benefit of this disclosure that many more modifications than those mentioned above are possible without departing from the inventive concepts disclosed herein. For example, one of ordinary skill in the art would readily appreciate that individual features from any of the exemplary aspects disclosed herein may be combined to generate additional aspects that are in accordance with the inventive concepts disclosed herein.

It is further understood that any combination of elements or steps described herein may be used alone or in combination with still further unrecited elements or steps. To that end, any reference to the transitional phrase “comprising” recited herein is expressly understood to also include support for alternative aspects directed to a closed set (i.e., “consisting of only the recited elements) and for a semi-closed set (i.e., “consisting essentially of the recited elements and any additional elements or steps that do not materially affect the basic and novel characteristics of the invention).

Although illustrative exemplary aspects have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A storage vessel, comprising:
a container and a cap, wherein the cap is configured to attach to the container;
one or more sensors, positioned within the container;
a lock, incorporated into the cap;
a reservoir, positioned within the container and comprising a sealed compartment configured to hold an adulterant; and
a piercing means, positioned within the container and configured to release the adulterant from the reservoir in response to a signal generated by the one or more sensors.

2. The storage vessel of claim 1, wherein the cap is further configured to form an airtight seal when attached to the container.

3. The storage vessel of claim 1, wherein at least one of the one or more sensors comprises: an air pressure sensor, a temperature sensor, a humidity sensor, an accelerometer, or any combination thereof.

4. The storage vessel of claim 1, wherein the lock comprises a mechanical lock or an electronic lock.

5. The storage vessel of claim 1, wherein the piercing means comprises a spring-loaded pin or blade.

6. The storage vessel of claim 1, wherein the adulterant comprises: a dye, a bitter-tasting substance, a foul-smelling substance, or any combination thereof.

7. The storage vessel of claim 1, further comprising one or more of: a radio frequency identification (RFID) tag or a global positioning system (GPS) sensor.

8. The secure storage vessel of claim 1, wherein the sensor comprises an air pressure sensor configured to trigger release of the adulterant when a pressure level in the secure storage vessel meets or exceeds a threshold level.

9. The storage vessel of claim 1, wherein the container comprises a bottle or canister.

10. A method for transporting a controlled substance, comprising:
placing the controlled substance in the storage vessel of claim 1;
locking the secure storage vessel;
transporting the secure storage vessel to a new location; and optionally, opening the secure storage vessel.

11. The method of claim 10, further comprising:
reducing the air pressure level in the storage vessel after placing the controlled substance in the storage vessel, wherein the sensor comprises an air pressure sensor and the cap is configured to form an airtight seal when attached to the container.

12. The method of claim 10, wherein the sensor is configured to trigger release of the adulterant when a pressure level in the storage vessel meets or exceeds a threshold level.

13. A device for securing a container, comprising:
a cap configured to seal a container, wherein the cap comprises
an outer housing containing a processor configured to execute programmable logic;
a sensor capable of detecting and/or measuring one or more parameters and transmitting a signal to the processor based on the detected and/or measured parameters; and
an adulterant dispenser, configured to produce and/or release an adulterant;
wherein the processor is programmed to trigger production and/or release of the adulterant, by the adulterant dispenser, when the sensor detects and/or measures a level of a parameter that meets or exceeds a pre-set threshold.

14. The device of claim 13, wherein the cap is adapted to seal a container using a threaded interface.

15. The device of claim 13, wherein the adulterant dispenser is:
a) integrally attached to the outer housing; or
b) detachably attached to the outer housing.

16. The device of claim 13, where the sensor is configured to detect and/or measure:
a) a level of air pressure;
b) a level of humidity;
c) a radiofrequency or electromagnetic signal; and/or
d) GPS coordinates.

17. The device of claim 13, wherein the cap further comprises a locking mechanism configured to secure the cap to the container when in a locked state, and to allow removal of the cap when the locking mechanism is in an unlocked state.

18. The device of claim 17, wherein the processor is programmed not to trigger production and/or release of the adulterant, by the adulterant dispenser, when the locking mechanism is in the unlocked state.

19. The device of claim 17, wherein the locking mechanism is a mechanical lock that can be switched into a locked or unlocked state using a physical key, a key code, or a wireless signal.

20. The device of claim 13, wherein the adulterant comprises one or more of the following:
a) a dye;
b) a foul-tasting compound;
c) a foul-smelling compound;
d) a compound that forms a foam when released, at a volume sufficient to fill the container when released; or
e) heat, light, and/or electromagnetic radiation.
